(19) United States
(12) Patent Application Publication
(10) Pub. No.: US 2013/0100657 A1
(43) Pub. Date: Apr. 25, 2013

(54) PLANAR ILLUMINATING DEVICE

(71) Applicant: SEI-PING LOUH, Tu-Cheng (TW)

(72) Inventor: SEI-PING LOUH, Tu-Cheng (TW)

(73) Assignee: HON HAI PRECISION INDUSTRY CO., LTD., Tu-Cheng (TW)

(21) Appl. No.: 13/300,647

(22) Filed: Nov. 20, 2011

(30) Foreign Application Priority Data
Oct. 25, 2011 (TW) 100138747

(51) Int. Cl. F21S 4/00; F21V 7/00

(52) U.S. Cl. 362/225; 362/235; 362/249.01

(57) ABSTRACT

A planar illuminating device includes a number of light sources and an optical sheet positioned at a side of the light sources. The optical sheet includes an incident surface facing the light sources and an emergent surface opposite to the incident surface. The incident surface includes a number of protruding prism structures. The emergent surface includes a number of concave diffusing micro-structures.

### BACKGROUND

1. Technical Field

The present disclosure relates to illuminating devices and, particularly, to a planar illuminating device.

2. Description of Related Art

Planar illuminating devices are applied in many fields, such as display panels and advertising panels. A planar illuminating device typically includes a light source, a prism sheet, and a diffusing sheet. The prism sheet and the diffusing sheet are positioned at a light emergent side of the light source for increasing the utilization ratio (i.e., brightness) and uniformity of light, respectively.

However, the prism sheet and diffusing sheet are separated optical members, and, in assembly, the prism sheet and the diffusing sheet should be accurately positioned relative to each other, and then be aligned with the light source, which is difficult and accordingly increases cost and/or decreases efficiency.

What is needed therefore is a planar illuminating device addressing the limitations described.

### BRIEF DESCRIPTION OF THE DRAWINGS

The components of the drawings are not necessarily drawn to scale, the emphasis instead being placed upon clearly illustrating the principles of the embodiments of the planar illuminating device. Moreover, in the drawings, like reference numerals designate corresponding parts throughout several views.

FIG. 1 is a schematic view of a planar illuminating device, according to an exemplary embodiment of the present disclosure.

FIG. 2 is an enlarged view of part II of the planar illuminating device of FIG. 1.

### DETAILED DESCRIPTION

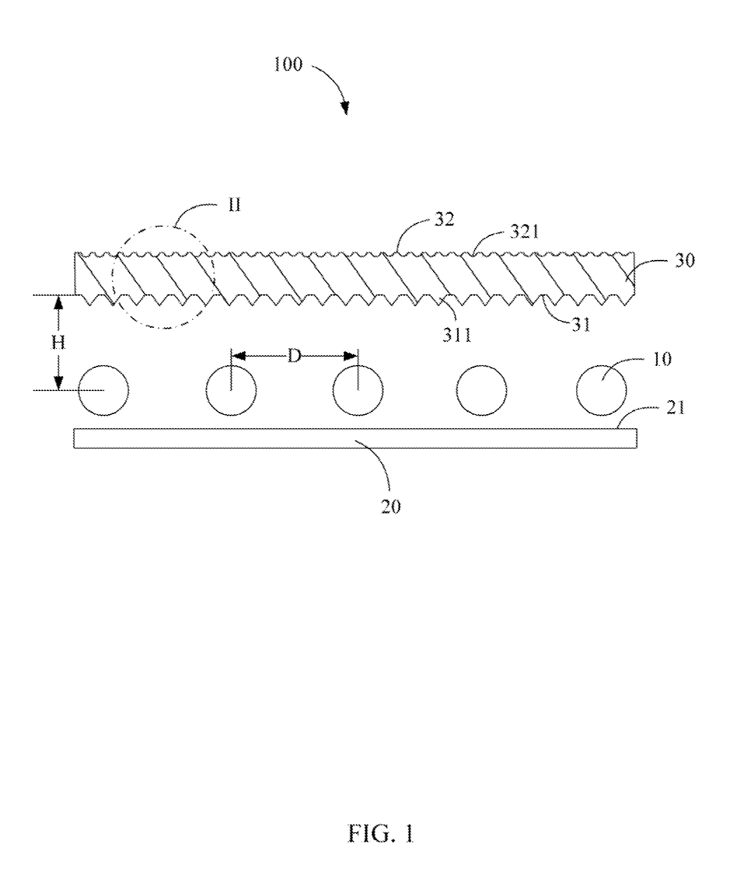

Referring to FIG. 1, a planar illuminating device 100, according to an exemplary embodiment, is shown. The planar illuminating device 100 includes a number of light sources 10, a reflector 20 and an optical sheet 30. The reflector 20 and the optical sheet 30 are positioned at opposite sides of the light sources 10.

The light sources 10 can be point light sources or linear light sources. In this embodiment, the light sources 10 are linear light sources and substantially parallel to each other. The light sources 10 can be selected from one type of light emitting diode (LED) and cold cathode fluorescent Lamp (CCFL). A distance between adjacent light sources 10 is D, in this embodiment, the value of D is about 20 millimeters.

The reflector 20 reflects light of the light sources 10 to the optical sheet 30. The reflector 20 includes a reflecting surface 21 facing the light sources 10.

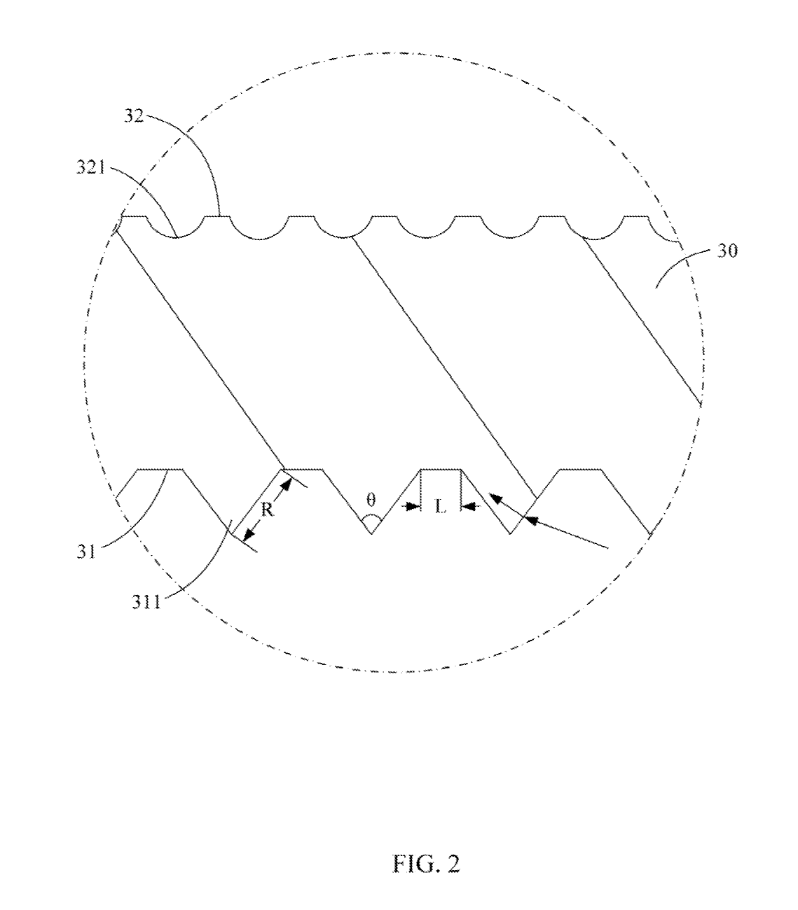

The optical sheet 30 increases the uniformity and the luminance of light of the planar illuminating device 100. The optical sheet 30 is made from a material having high transmittancy (more than 90%), such as glass, polymethylmethacrylate (PMMA), polycarbonate (PC), for example. The optical sheet 30 includes an incident surface 31 facing the light sources 10 and an emergent surface 32 away from the light sources 10. A perpendicular distance between the incident surface 31 and the light sources 10 is H, in this embodiment, the value of H is about 60 millimeters. The optical sheet 30 includes a number of prism structures 311 protruding from the incident surface 31. The prism structures 311 refract incident light at a predetermined angle. The prism structures 311 are integrally formed on the incident surface 31 of the optical sheet 30. In this embodiment, the prism structures 311 are elongated and substantially parallel to each other. A cross section of each prism structure 311 is isosceles triangle-shaped. Referring to FIG. 2, an angle of the cross section of each prism structure 311 opposite to the incident surface 31 is θ, a length of each side of the angle θ is R, and a distance between adjacent prism structures 311 is L. In this embodiment, a range of the value of the θ is 60-70 degrees, a range of the value of the R is 35-36 microns, and a range of the value of the L is 18-25 microns. When the value of θ, R and L satisfy above ranges, the planar illuminating device 100 has a higher luminance.

The optical sheet 30 further includes a number of diffusing micro-structures 321 formed on the emergent surface 32. Each diffusing micro-structure 321 includes a concave surface. The concave surface can be a spherical surface or an aspherical surface, in this embodiment, the concave surface is an aspherical surface. The diffusing micro-structures 321 can be formed on the emergent surface by method of injection molding, etching, engraving or transfer printing. The diffusing micro-structures can diffuse light passing through the emergent surface 32, thus can enhance light uniformity of the planar illuminating device 100.

In use, the light sources 10 emit light for use by the planar illuminating device 100, the light emitted from the light sources 10 is incident to the incident surface 31 directly or after being reflected by the reflector. The prism structures 30 refract incident light for a predetermined angle.

In the field of optics, when passing from a type of medium into another type of medium, light will be reflected and be refracted at the interface of the two mediums. The larger the incident angle, the more light is reflected. In addition, the more times the light is reflected, the more light loss occurs. If light enters into an optically thicker medium from an optically thinner medium, the refraction angle is larger than the incident angle. In the embodiment of the planar illuminating device 100, if incident light with a large incident angle (more than 30 degrees) relative to the incident surface 31 enters into the optical sheet through a side surface of a prism structure 311, while the incident light has a less incident angle relative to the side surface of the prism structure 20. Thus, the loss of incident light because of reflection is decreased.

The prism structures 311 and the diffusing micro-structures 321 of the planar illuminating device 100 are integrally formed on the optical sheet 30, eliminating the need of assembling an conventional prism sheet and diffusing sheet, showing insight that is contrary the understandings and expectations of the art.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A planar illuminating device, comprising:
a plurality of light sources; and
an optical sheet positioned at a side of the light sources, comprising:
an incident surface facing the light sources, the incident surface comprising a plurality of prism structures, the prism structures protruding from the incident surface; and
an emergent surface opposite to the incident surface, the emergent surface comprising a plurality of concave diffusing micro-structures defined therein.

2. The planar illuminating device of claim 1, wherein the light sources are linear light sources and substantially parallel to each other.

3. The planar illuminating device of claim 2, wherein a distance between adjacent light sources is 20 millimeters.

4. The planar illuminating device of claim 2, wherein a perpendicular distance between the incident surface of the optical sheet and the light sources is 60 millimeters.

5. The planar illuminating device of claim 1, wherein the prism structures are elongated and substantially parallel to each other.

6. The planar illuminating device of claim 5, wherein a distance between adjacent prism structures is in a range of 18-25 microns.

7. The planar illuminating device of claim 5, wherein a cross section of each prism structure is isosceles triangle-shaped.

8. The planar illuminating device of claim 7, wherein an angle of the cross section of each prism structure opposite to the incident surface is in a range of 60-70 degrees.

9. The planar illuminating device of claim 7, wherein a length of each side of the angle of the cross section of each prism structure opposite to the incident surface is in a range of 35-36 microns.

10. The planar illuminating device of claim 1, wherein a surface of each diffusing micro-structure is a spherical surface.

11. The planar illuminating device of claim 1, wherein a surface of each diffusing micro-structure is an aspherical surface.

12. The planar illuminating device of claim 1, further comprising a reflecting sheet position at another opposite side of the light sources.
